(19) United States
(12) Patent Application Publication
(10) Pub. No.: US 2006/0284851 A1
(43) Pub. Date: Dec. 21, 2006

(54) Programmable orientation handwriting recognition system and method

(76) Inventor: John Stephen Pittman, Colmesneil, TX (US)

Correspondence Address: DAFFER MCDANEIL LLP, P.O. BOX 684908, AUSTIN, TX, 78768, US

(21) Appl. No.: 11/153,777

(22) Filed: Jun. 15, 2005

(51) Int. Cl. G09G 5/00

(52) U.S. Cl. 345/173

(57) ABSTRACT

A system and method are provided for recognizing handwritten alphanumeric characters placed at varying, programmable angles across a display device. Therefore, the system and method can recognize handwritten characters entered at different angles, yet maintains other textual information at a horizontal angle relative to the display device. Therefore, a user can enter handwritten information at any desired angle convenient and less cumbersome to the user, yet allows a user to read text at the natural, horizontal display position as if the display is presented within the horizontal viewing angle of the user. This prevents the user from having to tilt his/her head to read text arranged at the same angle as the handwritten input.

### BACKGROUND OF THE INVENTION

1. Field of the Invention

The present invention relates in general to a system and method for recognizing handwritten characters that can be written at various programmable angles across a display screen, and for converting those handwritten characters to text.

2. Description of the Related Art

The following descriptions and examples are not admitted to be prior art by virtue of their inclusion within this section.

There are numerous mechanisms currently used for entering handwritten information into a computer. Typically, the computer includes a digitizing surface that provides a two-dimensional coordinate input surface. A popular type of computer which has a digitizing surface is known as a tablet personal computer or tablet PC.

A tablet PC generally includes an input device that communicates with the coordinate input surface or electronic display. The input device is oftentimes referred to as a pen-type stylus since most such input devices are shaped like a pen. An operator will grasp the pen similar to a handwriting instrument, and move the pen similar to a way in which a person might sign his or her name on a sheet of paper. The signature would appear on the tablet and be stored in memory in one form or another.

There are numerous types of pen-type styluses on the market, some of which are un-tethered or wireless and others are coupled to the tablet PC through a wire. The pen can communicate to the tablet PC by either contacting the pen tip to the electronic display surface or maintaining the tip a spaced distance from the surface, while moving the tip in a handwriting pattern. Examples of pen-type styluses, coordinate input systems, and the communication therebetween are described in, for example, U.S. Pat. Nos. 6,577,299; 5,565,623; 5,004,871; 4,814,552; and 4,786,765 herein incorporated by reference.

While the handwritten information can be entered and displayed onto the electronic display by moving the stylus, there are also numerous mechanisms and algorithms available for recognizing the handwritten indicia or characters and converting those handwritten characters into text. Thus, instead of depressing sequential keys on a QWERTY keyboard in order to formulate text characters sent to a computer, a user can write characters using his/her familiar handwriting, and a program can convert that handwritten character into a text character. As described in U.S. Pat. Nos. 5,410,141; 4,757,551; 4,845,768; 4,701,960 herein incorporated by reference, handwriting recognition tools depend on certain factors to achieve reliable, high quality recognition and conversion.

Many handwriting recognition tools depend on the handwritten characters being of a particular size. That is, the handwritten characters must meet certain minimum demands in terms of shape, size, slant, etc. The characters must not be excessively broad or excessively high because they may not fit within a prescribed scanning window. Moreover, the characters must not have excessive slant because the classifier might be distributed by character parts from adjoining, neighboring characters. Accordingly, most handwriting recognition programs require that the handwritten characters be placed along a line. That line is typically horizontal with a bottom lateral surface of the electronic display. However, if a user is left-handed or right-handed, the degree of slant can significantly vary if attempting to write along a horizontal line, and also to write within the prescribed field surrounding that horizontal line. Unfortunately, however, the natural handwriting position for users is to slant the writing surface slightly, depending upon the degree of slant comfortable for a user, and whether the user is right-handed or left-handed.

Accordingly, it would be desirable to introduce a system and method that can recognize handwritten information that can be written at a slant angle relative to other textual information that would appear horizontally across an electronic display. The degree of slant is preferably programmable to take into account user preferences. By introducing such a desirous system and method, handwritten information can be comfortably input into the computer and thereafter reliably converted to text, yet allowing the user to read other textual information without forcing the user to slant his/her head or change his/her view angle.

### SUMMARY OF THE INVENTION

The problems outlined above are in large part solved by a system that can provide handwritten characters to a computer. The system is one that recognizes handwritten information, and converts such information into text. As used herein, handwritten information would be the movement of any form of input mechanism. Such a mechanism includes anything that would allow entry of information into a computer, such as but not limited to a finger for use in a touch screen display, or a writing instrument such as a elongated member grasped by a user. The writing instrument can include a pen-type stylus. The user can move his finger or any other type of input mechanism, such as the stylus, similar to stroke or scroll movements when writing various characters, symbols, numbers, and the like. Text, on the other hand, is the characters, symbols, and numbers to which the handwritten information is converted. Therefore, the text would be what would be entered and/or appear if a user were to depress various keys on a keyboard. Not all handwritten characters are easily converted to text. However, by implementing a system that can present the field of entry at an angle comfortable for a user when scrolling his/her pen, it is more likely that the handwritten characters can be entered in a way that they are recognizable to the conversion mechanism, routine, or algorithm.

According to one embodiment, the system includes an electronic display. Extending along a horizontal axis of the display can be a window, similar to a window which would appear using Microsoft Windows® operating system. A region or field within the window can be oriented at an angle relative to the horizontal axis. Therefore, handwritten characters can be written into the region and more reliably converted to text (i.e., text entry) that is input to the computer.

Therefore, the handwritten characters are in a natural handwriting style of a user, whereas the text or text entry comprises what would normally be printed from or displayed on computer device if, for example, a user depresses a key upon a keyboard. The region preferably comprises a line oriented along an non zero degree angle relative to the other text upon the display. The region is used for guiding a user to move a stylus pen device along the line to form the handwritten characters (as used herein, the term character or characters represents any information that can be entered in handwritten form, including alphanumeric information, symbols, etc.).

According to yet another embodiment, a method is provided for converting handwritten information into textual information. The handwritten information can then be inserted into a document that may contain the textual information. Thus, a document can be opened containing text extending along a horizontal axis parallel to a lateral edge of a screen nearest a user. A position is entered among the text by pointing a pen device to the position and actuating the pen device. Textual information is then inserted at the position by moving a pen device across the screen at an angle relative to the horizontal axis to form handwritten information. The handwritten information is then converted into textual information, and the textual information is displayed at the selected position among the text.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a front elevation view of a display screen onto which handwritten characters are written horizontally across the screen at an angle relative to a field of sight;

FIG. 2 is a front elevation view of the display screen within the field of sight of a user;

FIG. 3 is a front view of a messaging window appearing on the display screen, and an icon that may appear whenever the stylus input device is projected near the screen, according to one example;

FIG. 4 is a front view of an input panel appearing on the display screen in response to selecting the icon;

FIG. 5 is a front view of the input panel having several pull-down horizontal lines upon which handwriting characters can be entered horizontally across the display screen and the corresponding text dynamically appearing beneath each line;

FIG. 6 is a front view of the input panel having several pull-down lines programmably reoriented at an angle relative to the horizontal lines of FIG. 5 and relative to the horizontal, lower surface of the display screen; and

FIG. 7 is a block diagram of an execution engine operably coupled to receive graphics rendering instructions that configure at various angles the lines upon which handwriting characters are entered in order to allow a user to enter their handwriting at an angle relative to the display screen and other information presented on the display.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, FIG. 1 illustrates a handwriting input device 10. Device 10 may include a computer and a display screen surface 12. The overall computer and display screen can be integrated into one another to form, for example, a tablet personal computer, or tablet PC. The computer of the tablet PC can execute various operating systems (OSs). A popular tablet PC OS is Windows XP® developed by Microsoft Corporation. Specifically, Microsoft Corporation developed a program known as Microsoft Windows XP Tablet PC Edition® that is designed to operate on a tablet PC, or generally on an input device that can receive handwritten characters presented from a pen-type stylus.

Windows XP Tablet PC operating system includes a specific type of window that can be launched by clicking the stylus input device when the cursor is placed upon an icon shown on the display. For example, a messaging window 14 may be presented on display 12. The format of messaging window 14 can be similar to an email message with a “TO,” “CC,” “Subject,” and textual message fields. Generally speaking, a user will depress one or more keys on a keyboard to enter text into the various fields. Using a special type of program known as tablet PC input panel 16, a user can enter information into one or more fields of window 14 by scrolling pen stylus 18 across a region identified by line 20. Whatever is written across line 20 will be recognized by the tablet PC input panel program, and converted to text that will then be placed in the selected region of window 14. The selected region is where the input device previously existed as shown by position demarcation line 22. Thus, for example, if the handwritten characters represent “John Doe,” the handwritten characters will be converted to text characters and presented on the “TO” input line beginning at position 22.

To open the tablet PC input panel 16, the user simply selects the input panel icon and the input panel window 16 will appear on the screen. The user can then select different formats for the input panel window, as either a writing pad, a character pad, or an on-screen keyboard. As shown, input panel 16 is configured as a writing pad to allow a user to handwrite characters across line 20, whereupon the input panel program will then recognize those characters and convert them to text information that would normally appear if a user were to depress a key on a keyboard, such as a QWERTY keyboard. However, input of handwriting information can be more convenient than entering information from a keyboard in certain circumstances. Details of how the tablet PC input panel operates as a tool within Microsoft Windows XP Table PC Edition®, and further details of the handwriting recognition program within the tablet PC input panel are described on the Internet at www.microsoft.com.

A review of materials from Microsoft Corporation indicates that the handwritten characters must scroll within the defined region and along line 20. Therefore, line 20 is arranged horizontally across screen 12 and parallel to the horizontal axis 24. The horizontal axis is drawn conveniently along the lateral edge, closest to a user 26. However, it is understood that horizontal axis can be drawn anywhere across the input device 10 as long as the axis is parallel to both the upper and lower lateral edges.

User 26 is shown to conveniently and more comfortably tilt input device 10 into a position that allows the user to write across line 20. For example, for a right-handed user, the writing surface is generally tilted relative to the user in order for the user to scroll across a tilted line more easily than if the writing surface is not tilted. The same can be said for a left-handed user except that the tilt angle may be quite dissimilar from that of a right-handed user. Moreover, depending on the user, the degree of tilt, whether the users are right- or left-handed, will vary.

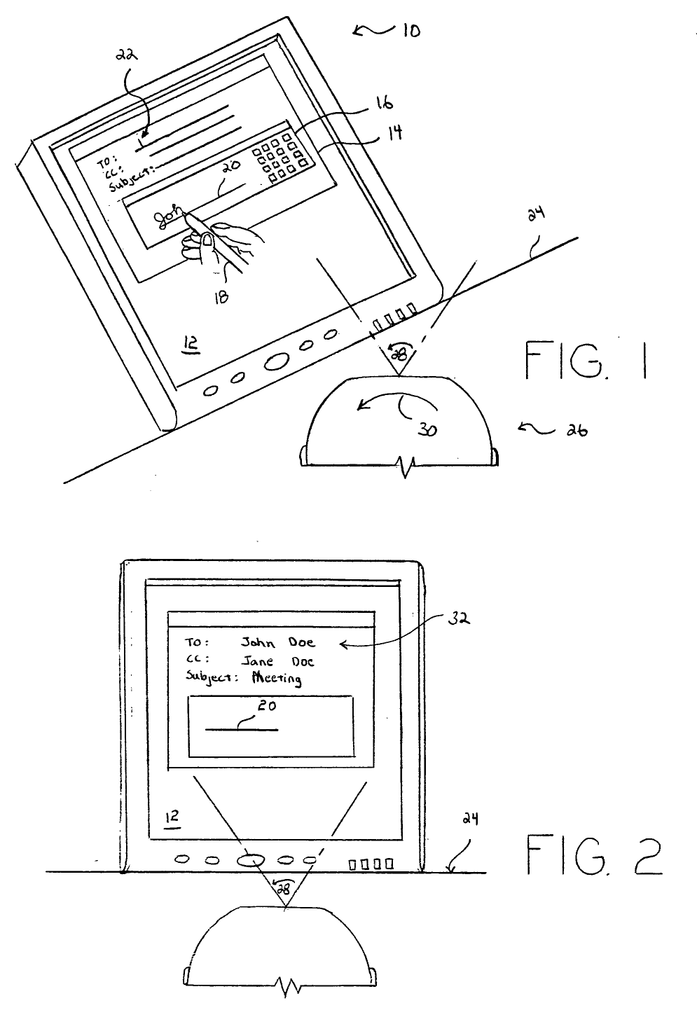

An unfortunate aspect of having to tilt the writing surface or screen surface 12 relative to a user in order to allow ease of handwriting along a line 20 is that the screen surface will be drawn outside of the forward-looking view angle 28 of user 26. As such, in order to read text that appears on screen 12 along the horizontal axis 24, a user must rotate his/her head to readjust the view angle from a forward-looking direction to a slanted or angled direction as shown by rotation 30. Rotating a user's head to allow a better view angle while writing along line 20 can cause the user to tilt his/her head for extended periods of time. This may lead to stress in the neck or strain in the eyes of the user. As shown in FIG. 2, it is more desirable that the view angle 28 be forward-looking directly upon screen 12 and, specifically, the text 32 displayed on screen 12. However, writing along a line 20 that is parallel to the horizontal axis 24 is not only cumbersome and uncomfortable as a writing position, but also can lead to improper and inaccurate scrolling of the pen across line 20. If the handwritten information is not accurately written, possibly due to having to conform the user's hand in an uncomfortable and unnatural position, the handwritten information will not be accurately converted to text using the various handwriting recognition programs available in the market, including the recognition software developed for the tablet PC input panel when placed in a writing pad configuration.

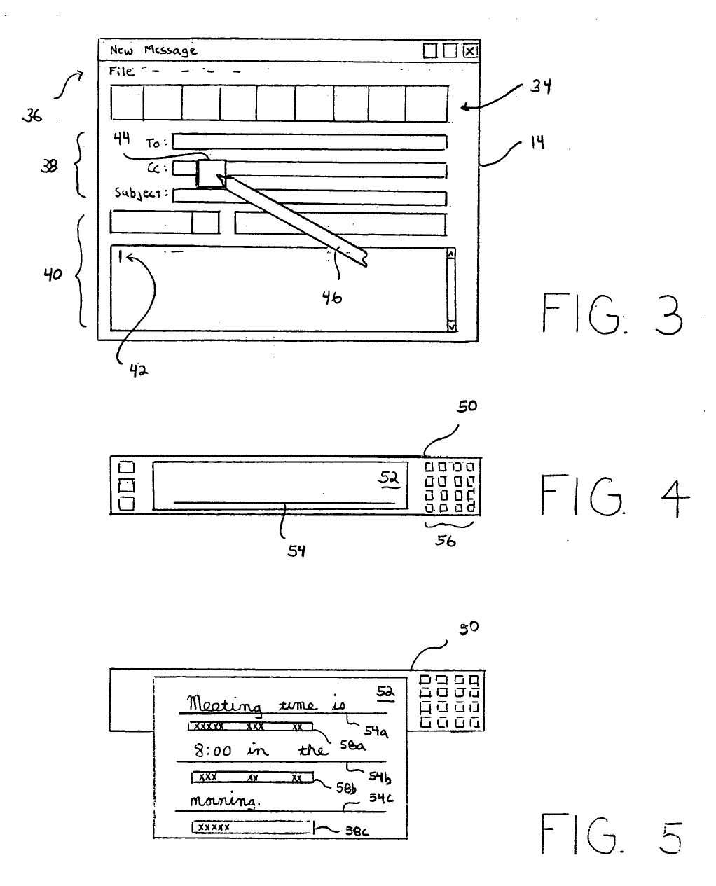

Thus, it would be desirable to implement a handwriting recognition program that allows the pop-up screen or window to display an angle region, possibly demarcated by a line. The angled region is angled at a non-0° or non-180° degrees relative to other text displayed on the screen. This will allow a user to handwrite information in his/her natural and comfortable handwriting position, yet will preclude the user from having to tilt his/her head to read text also presented on the screen. Details of the angle region relative to text and the mechanism and methodology thereof is described in reference to FIGS. 3-7.

Turning to FIG. 3, an example of a messaging window 14 that is presented when a user wishes to send a new message or email is shown. For example, the messaging window 14 can include numerous icons 34, beneath the pull-down menu 36, e.g., “File,” “Edit,” “View,” “Tools,” “Help,” etc. near the top of window 14. Beneath icons 34 is the “TO,” “CC,” and “Subject” fields 38. Below fields 38 is a messaging field 40.

Messaging window 14 is an example of possibly numerous different types of windows that can be presented upon a display screen. Other such windows include any window that includes text and/or fields which can be written to using a user's natural handwriting style. Regardless of the window chosen and whether that window is a messaging window or any window containing text, it is preferred that wherever the input device is graphically represented on the window, such as position 42, a pull-down window or pop-up window can be initiated to enter handwriting at position 42. For example, utilizing Microsoft Windows XP Tablet PC Edition® software, a tablet PC input panel icon 44 will appear when the user places the tip of a stylus pen 46 near the field that the user wishes to complete. In the example shown, the user may wish to enter a message at position 42 within field 40, so he/she places the tip of pen 46 near field 40. Alternatively, the user can tap the screen with the tip of pen 46, and the tablet PC input panel icon 44 will appear at that position.

Once icon 44 appears, the tip of the stylus 46 can be placed onto the screen at the position of icon 44 to select icon 44. In doing so, an input panel 50 will appear somewhere on the screen. There are numerous modes in which the input panel 50 can be configured. For example, one mode is that of a writing pad shown in FIG. 4 which contains a field 52 in which handwritten characters can be entered. Within field 52 is a line 54 across which the user must scroll the pen-type stylus tip as described in FIGS. 1 and 2. If the user desires not to use a writing pad configuration, the user might configure the input panel as a character pad or as having an on-screen keyboard to allow the user to enter characters by tapping the screen at the select positions 56 of the various keys to compile the necessary character set. Selecting the keys in sequence then presents the appropriate alphanumeric text characters at the selected position 42. However, if configured as a writing pad, then the handwritten characters are converted to text characters that are then placed at position 42.

The layout of window 14 (FIG. 3) is an example of many types of possible layout configurations of a window containing text, into which converted handwritten characters are inserted. Window 50 (FIG. 4) is also merely an example of a window that can receive handwritten characters. It is contemplated that any window containing text into which converted handwritten characters are inserted, fall within the spirit and scope of the handwriting recognition programs available in the marketplace which convert handwritten characters into text characters inserted at a desired point.

FIG. 5 illustrates a writing pad that extends to multiple lines 54a, 54b, and 54c across window 52. Depending on the amount of handwritten characters needing to be entered, there may be certainly more than one line presented and can be certainly more than three lines presented. As the handwritten characters are written across each line, a field 58a, 58b, and 58c beneath each line is preferably automatically updated to include the text characters that are converted from the handwritten characters. The text characters as explained above are what would appear if a user were to depress keys on a keyboard. The text characters can be configured in any type of font and displayed in field 58.

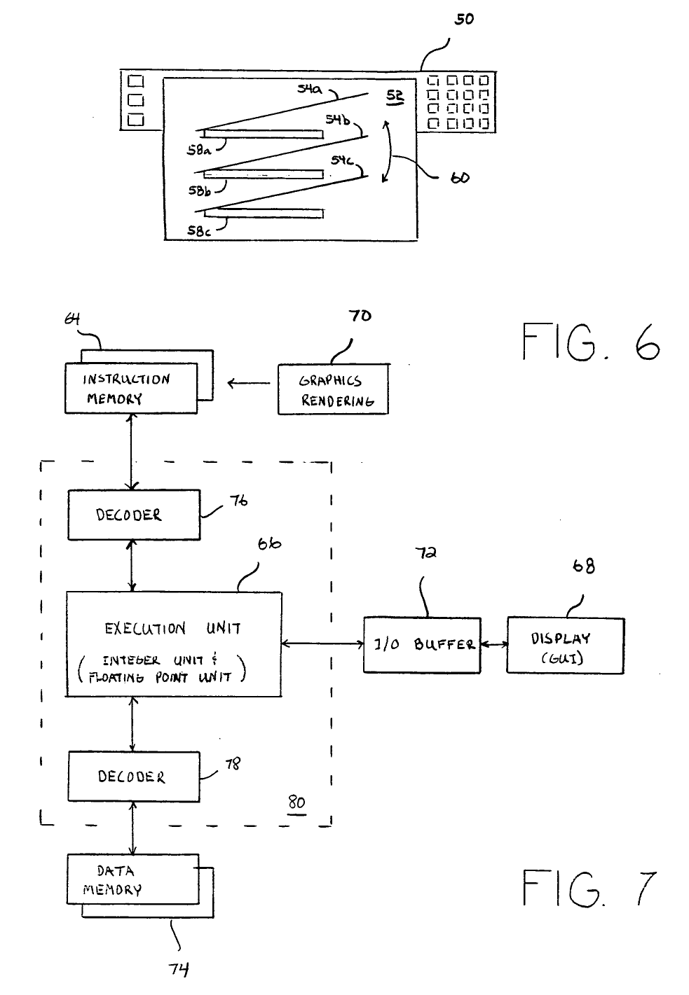

By modifying the graphics rendering program, the line 54 can be extended at any programmable angle. Thus, line 54a, 54b, and 54c shown in FIG. 6 can be tilted at any programmable angle shown by arrow 60. The degree of tilt can be adjusted depending upon the user's preference. Preferably, a right-hand user might select a positive angle between, for example, 10° and 70°, whereas a left-hand user might select an angle between, for example, 100° and 160°, wherein the angle is measured relative to a horizontal axis. However, the corresponding text beneath the angled line 54 at field 58a, 58b, or 58c remains along a horizontal axis for ease of viewing. While FIG. 6 illustrates three angled lines, it is appreciated that as few as one angled line or more than three angled lines can be configured to allow a user to write along the angled lines, yet read text that remains horizontally configured.

Modifications to the graphics rendering of the entry field and line associated with the entry of handwritten characters is achieved by modifying the angle at which line 54 is presented. As shown in FIG. 7, contained within instruction memory 64 is a program that comprises a series of instructions. Part of those instructions include fetch operations which instruct an execution unit 66 to fetch a series of instructions that tell a display unit 68 where to display a particular graphics rendering. By modifying the instruction memory 64 with a different graphics rendering display program 70, whenever execution unit 66 performs a fetch operation, the fetch operation will instruct the execution unit to produce a different output sent to display 68 through an a buffer 72.

Thus, whatever program is needed to produce a display can be modified to present that display at an angle, rather than horizontally across the screen. The degree of angle can be modified based on changes to the graphics rendering program 70. Those changes can occur by either changing data in the data memory 74 or changing the graphics rendering program via an input device connected to execution unit 66. Before execution unit 66 can perform its operations, whatever is contained in the instruction memory and data memory must be decoded through corresponding decoders 76 and 78. The combination of execution unit 66 and decoders 76 and 78, as well other digital subsystems are generally found either on a single integrated circuit or dispersed among many integrated circuits which form a processor generally associated with a computer 80. Therefore, computer 80 can receive input which can modify its stored programs and, especially, the program which produces lines or pixels across a screen. The lines or pixels arranged in a line can be presented at any angle configurable to a user in order to allow handwritten characters to be written along that angled line, while maintaining other pixels in their normal horizontal skew, such pixels representative of text that is also presented on the screen or display.

It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system for providing handwritten characters to a computer, comprising:
an electronic display;
a window extending along a horizontal axis of the display;
a region within the window oriented at a non-zero degree angle relative to the horizontal axis across which handwritten characters are written and converted to text entry to the computer.

2. The system as recited in claim 1, wherein the electronic display comprises a digitizing tablet.

3. The system as recited in claim 1, wherein the horizontal axis of the display is parallel to a lateral edge of the electronic display.

4. The system as recited in claim 3, wherein the lateral edge is nearest a user of the electronic display.

5. The system as recited in claim 1, wherein the bottom of the window is parallel to the horizontal axis.

6. The system as recited in claim 1, wherein the region comprises a line oriented along the angle for guiding a user to move a stylus pen device along the line to form the handwritten characters.

7. The system as recited in claim 1, wherein the handwritten characters are in the natural handwriting style of a user.

8. The system as recited in claim 1, wherein the text entry comprises what would be entered to a computer and displayed on the display device if a user depresses a key upon a keyboard.

9. A computer system for recognizing handwritten information into text, comprising:
an electronic display;
a window presented upon the display, along with textual information extending horizontally across the screen; and
a region within the window for entering handwritten information at an angle relative to the textual information.

10. The computer system as recited in claim 9, wherein a bottom of the window and the textual information each extend parallel to a lateral edge of the display nearest a user.

11. The computer system as recited in claim 9, wherein the region comprises a line oriented along the angle for guiding a user to move a stylus pen device along the line to form the handwritten information.

12. The computer system as recited in claim 9, wherein the textual information comprises information entered to a computer and/or displayed on the display device when a user depresses a key upon a keyboard.

13. The computer system as recited in claim 9, wherein the angle is programmable by a user of the computer system.

14. The computer system as recited in claim 9, wherein the angle is programmable from 0° to +90° or from 0° to −90° relative to horizontal depending on whether the handwritten information is written by a user who is right handed or left handed.

15. A method for converting handwritten information into textual information inserted into a document, comprising:
opening a document containing text extending along a horizontal axis parallel to a lateral edge of the screen nearest a user;
entering a position among the text by pointing a pen device to the position and actuating the pen device;
inserting textual information at the position by:
moving a pen device across the screen at an angle relative to the horizontal axis to form handwritten information;
converting the handwritten information into textual information; and
displaying the textual information at the position among the text.

16. The method as recited in claim 15, wherein said entering comprises placing a tip of the pen device approximate to the position and depressing a button on the pen device.

17. The method as recited in claim 15, wherein said moving comprises maintaining the pen device a spaced distance from the screen while moving the pen in a handwriting motion.

18. The method as recited in claim 15, wherein said moving comprises touching the pen device to the screen while moving the pen in a handwriting motion.

19. The method as recited in claim 15, wherein said converting comprises executing a handwriting recognition program.

20. The method as recited in claim 15, wherein said displaying comprises presenting the textual information along the horizontal axis between a pair of neighboring characters of the text.
